(19) United States
(12) Patent Application Publication
(10) Pub. No.: US 2024/0240865 A1
(43) Pub. Date: Jul. 18, 2024

(54) FIRING FURNACE

(71) Applicant: DENKEN-HIGHDENTAL Co., Ltd., Kyoto-shi, Kyoto (JP)

(72) Inventor: Atsuhiko IWASAKI, Kyoto-shi, Kyoto (JP)

(21) Appl. No.: 18/560,042

(22) PCT Filed: May 9, 2022
(86) PCT No.: PCT/JP2022/019697

§ 371 Date: Nov. 9, 2023

(30) Foreign Application Priority Data
May 10, 2021 (JP) 2021-079650

(51) Int. Cl. F27B 17/02; F27D 19/00; H05B 6/06; H05B 6/10; H05B 6/42; A61C 13/083

(52) U.S. Cl. CPC F27B 17/025; F27D 19/00; H05B 6/06; H05B 6/105; H05B 6/42; A61C 13/083; F27D 2019/0003

(57) ABSTRACT

A firing furnace which can shorten the time required for firing is to be provided.

The firing furnace is for firing an object to be fired, and includes a coil and an induction heating element being placed at the inner diameter side of the coil, in which an induced current flows due to a magnetic field generated by the coil, and heat is generated due to the induced current. The induction heating element includes a hollow portion to place the object to be fired. The coil consists of a conducting wire wrapped around an axis as a center. The firing furnace further includes two flow path members placed between the coil and the induction heating element. The one flow path member is arranged at the inner diameter side of the other flow path member, and the two flow path members constitute a gaseous flow path parallel to the axis.

### BACKGROUND OF THE INVENTION

### Technological Field

The present invention relates to a firing furnace. More specifically, the present invention relates to a firing furnace that can reduce the time required for firing.

### Description of the Related Art

People may lose teeth due to carious teeth, periodontal diseases, or external wounds. In such cases, the missing tooth area is fitted with a denture, bridge, dental implant, or the like. A dental implant is an artificial tooth root that is placed inside a person's mouth. Dental implants have the advantage of being able to reduce the burden on other teeth and prolonging the life of the other teeth. For this reason, dental implants have recently become the most effective treatment for tooth loss. Typically, dental implants are produced by depositing dental porcelain made of ceramic powder on a metal frame made by casting or milling, and drying and firing the deposited dental porcelain. In recent years, dental implants have been fabricated by milling a semi-sintered zirconia disk into a tooth shape, firing it at about 1500 degrees Celsius, and bonding it to a metal frame after main firing.

A technique related to a firing furnace for firing dental porcelain made of ceramic powder containing zirconia is disclosed, for example, in Patent Document 1 below. Patent Document 1 below discloses a firing furnace that includes a coil and a heat dissipation device that is placed inside the coil and performs induction heating.

Further, Patent Document 2 below discloses a technique known as a quick firing method that can shorten the time required for firing. A firing furnace in which a susceptor (induction heating element) containing the material to be sintered is surrounded by a coil is disclosed in Patent Document 2 below. This coil consists of a water-cooled copper tube connected to a high frequency power supply unit. When current flows through the coil, the susceptor heats up. The heated susceptor acts as a heat sink and transfers heat to the firing material.

### PRIOR ART DOCUMENT

[Patent Document1] Japanese published unexamined application No. 2021-508
[Patent Document2] International publication No. 2012/057829

Heating methods for firing furnaces include a resistance heating method and an induction heating method. The resistance heating method is a method in which the object to be fired is heated by heat generated by the resistor due to the current flowing through the resistor. The induction heating method is a method in which a magnetic field generated by the coil causes an induced current to flow through an induction heating element, and the heated induction heating element heats the object to be fired. Compared to a firing furnace of the resistance heating method, a firing furnace of the induction heating method has an advantage that the temperature inside the firing furnace can be raised quickly and the time required for firing is short.

However, firing furnaces of the induction heating method still had problems of long firing time. In order to shorten the time required for firing in a firing furnace such as disclosed in Patent Document 1, it is sufficient to increase the amount of current in the coil and increase the frequency of the current in the coil. However, if the amount of current in the coil is increased excessively, there is a risk that the coil will be overheated beyond its allowable temperature limit due to the heat generated by the current flowing through the coil itself and the heat transmitted from the heated susceptor (induction heating element).

Therefore, by configuring the coil with a water-cooled copper pipe like the firing furnace disclosed in Patent Document 2, the coil can be cooled by the water flowing through the copper pipe and can prevent the coil from overheating. As a result, the time required for firing can be reduced.

However, when the coil is configured with a water-cooled copper pipe disclosed in Patent Document 2, the coil is water-cooled even though the heat generated by the coil itself in addition to the susceptor contributes to the heating of the object to be fired. For this reason, there was a problem with poor energy efficiency. Since a water circulation device is required, there is a problem in that the cost increases.

The above problems can also occur in firing furnaces for firing objects to be fired other than dental implants.

### SUMMARY OF THE INVENTION

The present invention is to solve the above problems, the purpose is to provide a firing furnace that can shorten the time required for firing while saving energy and cost.

According to one aspect of the present invention, a firing furnace for firing an object to be fired comprises: a coil, and an induction heating element being placed at an inner diameter side of the coil, in which induced current flows due to magnetic field generated by the coil, and generates heat due to the induced current, wherein the induction heating element includes a hollow portion for locating the object to be fired, and the coil is made of a conducting wire wound around an axis as a center, wherein the firing furnace further comprising: an inner diameter side flow path member and an outer diameter side flow path member placed between the coil and the induction heating element, wherein the inner diameter side flow path member is arranged at an inner diameter side of the outer diameter side flow path member, and the inner diameter side flow path member and the outer diameter side flow path member constitute a flow path of gas parallel to the axis.

Preferably, the conducting wire consists of a litz wire which includes multiple bare wires which are insulated from each other and twisted together.

Preferably, the firing furnace further comprises a first fan that promotes gas flow in the flow path.

Preferably, the firing furnace further comprises a heat insulating body including a groove extending in an outer diameter direction from the flow path.

Preferably, the induction heating element has a cylindrical shape with the axis as a center axis, and the heat insulating body includes a lower hole connected to the hollow portion, wherein the firing furnace further comprising a lifting and lowering unit moves up and down between a lower position where the lower hole is opened and an upper position where the lower hole is closed, and includes a top surface to place an object to be fired.

Preferably, the firing furnace further comprises a ceiling part covering an opening at a top of the induction heating element, a first measuring unit that hangs from the ceiling part to the hollow portion and measures a temperature of the hollow portion, and a first control unit that controls a current flowing through the coil based on the temperature measured by the first measuring unit.

Preferably, the firing furnace further comprises a second measuring unit that measures a temperature of the coil, and a second control unit that performs forced cooling control when the temperature measured by the second measuring unit exceeds a first temperature, wherein the forced cooling control includes at least one of stopping a current flowing through the coil and blowing air to the coil.

Preferably, the firing furnace further comprises a second fan that blows air to the coil.

Preferably, the induction heating element includes molybdenum disilicide.

According to the present invention, it is possible to provide a firing furnace which can shorten the time required for firing while saving energy and cost.

### BRIEF DESCRIPTION OF THE DRAWINGS

FIG. 1 is a cross-sectional view showing a configuration of firing furnace 100 in an embodiment of the present invention.

FIG. 2 is a cross-sectional view showing a configuration of litz wire 1a.

FIG. 3 is an enlarged view of the main part of FIG. 1.

FIG. 4 is a plan view showing the configuration of the lower heat insulating body 3 when viewed from above.

FIG. 5 is a first cross-sectional view explaining the operation of firing furnace 100.

FIG. 6 is a second cross-sectional view explaining the operation of firing furnace 100.

FIG. 7 is a diagram showing frequency characteristics of AC resistances.

### DETAILED DESCRIPTION OF EMBODIMENTS

Hereinafter, an embodiment of the present invention will be described with reference to the drawings. In the following description, the direction away from the axis AX (an example of an axis), which is the center axis of the coil 1, may be referred to as the outer radial direction, and the direction approaching the axis AX may be referred to as the inner radial direction.

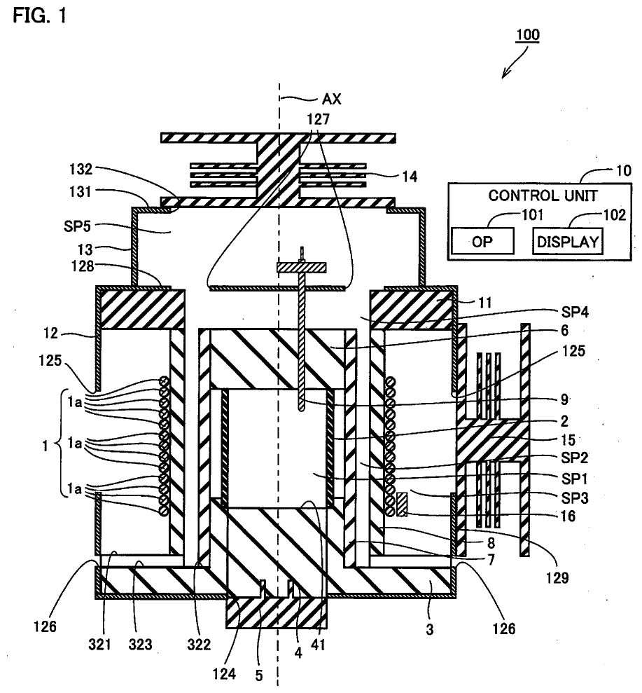

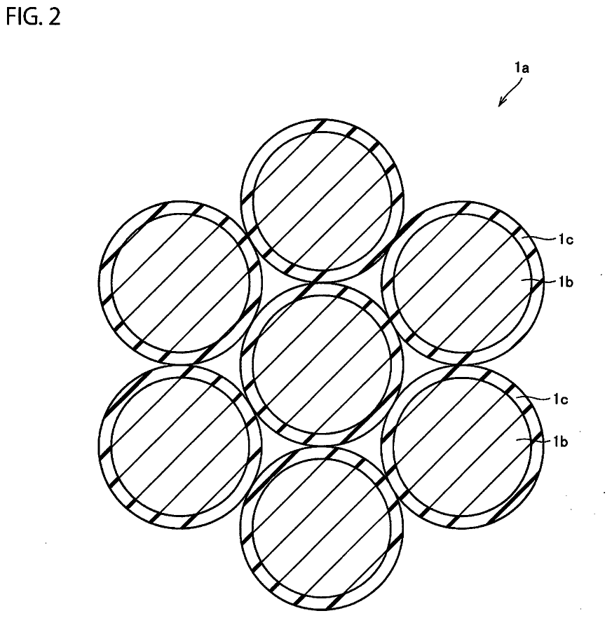

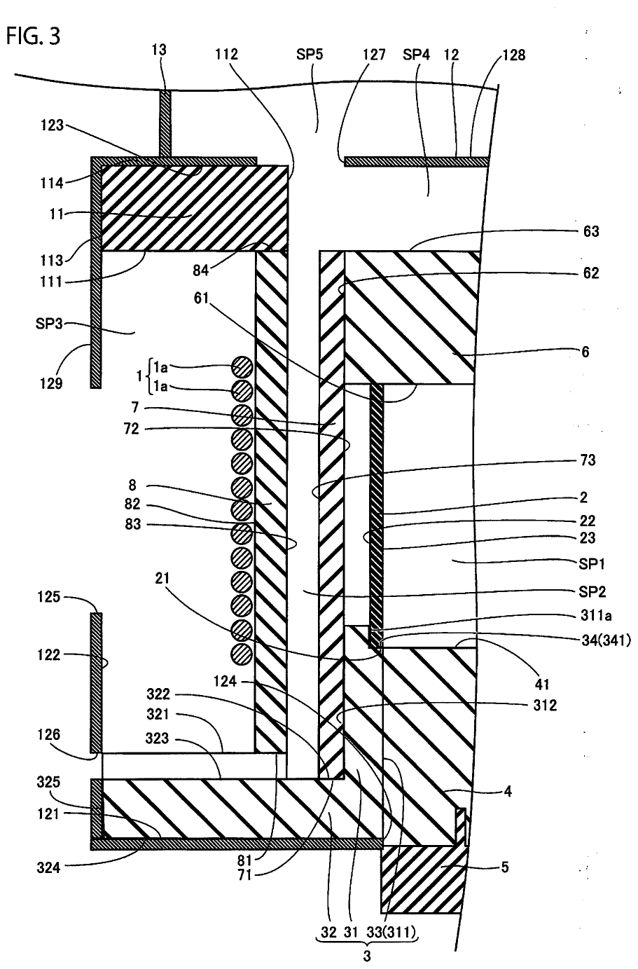

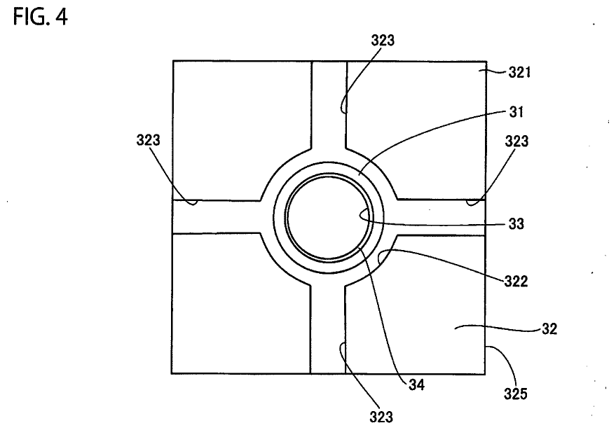

FIG. 1 is a cross-sectional view showing a configuration of firing furnace 100 in an embodiment of the present invention. FIG. 2 is a cross-sectional view showing a configuration of litz wire 1a. FIG. 3 is an enlarged view of the main part of FIG. 1. FIG. 4 is a plan view showing the configuration of the lower heat insulating body 3 when viewed from above.

Referring to FIGS. 1 to 4, firing furnace 100 (an example of a firing furnace) in this embodiment is a firing furnace which is for firing objects to be fired with the induction heating method. The object to be fired is, for example, a dental porcelain made of ceramic powder containing zirconia, etc. The object to be fired is arbitrary Firing furnace 100 has coil 1 (an example of a coil), induction heating element 2 (an example of an induction heating element), lower heat insulating body 3 (an example of a heat insulating body), lifting and lowering unit 4 (an example of a lifting and lowering unit), drive unit 5, ceiling part 6 (an example of a ceiling part), flow path member 7 (an example of an inner diameter side flow path member), flow path member 8 (an example of an outer diameter side flow path member), measuring unit 9 (an example of a measuring unit), control unit 10 (an example of a first and a second control units), upper heat insulating body 11, housing 12, overhanging part 13, fan 14 (an example of a first fan), and fan 15 (an example of a second fan).

Coil 1 consists of litz wire 1a (an example of a litz wire) wound around axis AX as a center. Particularly, with reference to FIG. 2, litz wire 1a includes a plurality of bare wires 1b (an example of bare wires). The plurality of bare wires 1b are insulated from each other by insulation films 1c. The plurality of bare wires 1b are twisted together. An alternating current is passed through the coil 1, which causes the coil 1 to generate a periodically fluctuating magnetic field. Note that coil 1 may consist of any conducting wire such as a copper wire, other than a litz wire.

Induction heating element 2 is arranged at the inner diameter side of coil 1. Induction heating element 2 has a cylindrical shape with axis AX as a center axis. An induced current flows through induction heating element 2 due to the magnetic field generated by coil 1. Induction heating element 2 generates beat due to this induced current and heats the object to be fired. Induction heating element 2 includes lower end face 21, outer surface 22, and inner circumferential surface 23. Induction heating element 2 is made of a material containing ceramics, and is preferably made of a material containing molybdenum disilicide. Because molybdenum disilicide has good heating efficiency of induced current and high thermal resistance. Induction heating element 2 includes hollow portion SP1 (an example of a hollow portion) for arranging the object to be fired. Hollow portion SP1 is partitioned by inner circumferential surface 23 of induction heating element 2.

Lower heat insulating body 3 is provided at the bottom of induction heating element 2. Lower heat insulating body 3 includes main body unit 31, flange part 32, lower hole 33 (an example of a lower hole), and recess 34. Main body unit 31 has a cylindrical shape with axis AX as a center axis Main body unit 31 includes inner circumferential surface 311 and outer surface 312. Inner circumferential surface 23 of induction heating element 2 and inner circumferential surface 311 of lower heat insulating body 3 constitute a continuous curved surface.

Flange part 32 extends from a lower end of main body unit 31 toward the outer diameter direction. With particular reference to FIGS. 3 and 4, flange part 32 has a generally square shape when viewed from above. Flange part 32 includes top surface 321, circular groove 322, straight groove 323 (an example of a groove), bottom surface 324, and outer surface 325. Top surface 321 of flange part 32 is planar, and circular groove 322 and straight groove 323 are each formed on top surface 321. Top surface 321 is divided into four approximately rectangular parts by circular groove 322 and straight groove 323, respectively. Circular groove 322 surrounds the outer periphery of main body unit 31. There are four straight grooves 323 in this embodiment. The four straight grooves 323 are provided so as to have equal center angles when axis AX is a center. The four straight grooves 323 extend from circular groove 322 in the outer diameter direction. In other words, each of the four straight grooves 323 extends in the outer radial direction from flow path SP2, which will be described later. The outer diameter side end of each of the four straight grooves 323 reaches the peripheral end of flange part 32 (of top surface 321).

Lower hole 33 is formed near axis AX of main body unit 31. Lower hole 33 is connected to hollow portion SP1 of induction heating element 2. Lower hole 33 is partitioned by inner circumferential surface 311 of lower heat insulating body 3.

Recess 34 is provided on the inner diameter side of the upper end of main body unit 31. Recess 34 is downwardly recessed along the axis AX direction. Lower end face 21 of induction heating element 2 is in contact with top surface 341 of recess 34. Outer surface 22 near a lower end of induction heating element 2 is in contact with portion 311aextending upward from recess 34 at inner circumferential surface 311 of main body unit 31.

Lifting and lowering unit 4 is fitted with lower hole 33. Lifting and lowering unit 4 has a cylindrical shape and has a size and shape corresponding to lower hole 33. Lifting and lowering unit 4 covers the lower opening of induction heating element 2. Lifting and lowering unit 4 includes stage 41 for placing objects to be fired (an example of a top surface to place objects to be fired).

Drive unit 5 is attached to the lower part of the lifting and lowering unit 4. Drive unit 5 raises and lowers lifting and lowering unit 4 between a lower position where lifting and lowering unit 4 opens lower hole 33 (In other words, a lower position where lifting and lowering unit 4 is below lower hole 33) and an upper position where lifting and lowering unit 4 closes lower hole 33 (In other words, an upper position where lifting and lowering unit 4 fits into lower hole 33).

Ceiling part 6 is provided above induction heating element 2. Ceiling part 6 covers the upper opening of induction heating element 2. Ceiling part 6 includes bottom surface 61, outer surface 62, and top surface 63. Induction heating element 2 is fixed to bottom surface 61 of ceiling part 6. Induction heating element 2 protrudes downward from bottom surface 61 of ceiling part 6. Hollow portion SP1 is sealed by the stage 41 of lifting and lowering unit 4 and bottom surface 61 of ceiling part 6.

Flow path members 7 and 8 are each placed between coil 1 and induction heating element 2. Flow path member 7 is arranged on the inner diameter side of flow path member 8. Flow path members 7 and 8 constitute a gaseous flow path SP2 parallel to axis AX. The gas flowing through flow path SP2 is air supplied from outside of housing 12 by fan 14. Any gas may be used to flow through the flow path SP2.

Flow path member 7 is fixed on flange part 32 and is arranged on the outer peripheral side of induction heating element 2. Flow path member 7 has a cylindrical shape with axis AX as a center axis. Flow path member 7 includes lower end 71, inner circumferential surface 72, and outer surface 73. Lower end 71 of flow path member 7 is placed in circular groove 322 of flange part 32. Inner circumferential surface 72 of flow path member 7 is fixed to each of the outer surface 62 of ceiling part 6 and the outer surface 312 of main body unit 31. Moreover, inner circumferential surface 72 of flow path member 7 is arranged on the outer circumferential side of induction heating element 2 being spaced apart from it. Flow path member 7 is preferably made of a material with high heat insulation properties and high thermal resistance such as ceramic.

Flow path member 8 is fixed to upper heat insulating body 11, and is arranged on the outer peripheral side of flow path member 7. Flow path member 8 has a cylindrical shape with axis AX as a center axis. Flow path member 8 includes lower end face 81, outer surface 82, inner circumferential surface 83, and upper end surface 84. A part of lower end face 81 of flow path member 8 is in contact with top surface 321 of flange part 32, and another part of lower end face 81 of flow path member 8 straddles the upper part of straight groove 323. Coil 1 is wound around the outer surface 82 of flow path member 8. The space partitioned by outer surface 73 of flow path member 7 and inner circumferential surface 83 of flow path member 8 is flow path SP2. One end (starting point) of flow path SP2 is upper end surface 84 of flow path member 8, and the other end (end point) of flow path SP2 is lower end face 81 of flow path member 8. The other end of flow path SP2 is connected to straight groove 323. Flow path member 8 is preferably made of a material with high heat insulation properties and high thermal resistance such as ceramic.

Measuring unit 9 is fixed to ceiling part 6, and hangs from ceiling part 6 to hollow portion SP1. Measuring unit 9 measures the temperature of hollow portion SP1 and transmits information (voltage value, etc.) indicating the measured temperature to control unit 10. A plurality of measuring units 9 may be provided in consideration of temperature unevenness in hollow portion SP1.

Control unit 10 controls the entire firing furnace 100. Control unit 10 controls the current flowing through coil 1 based on the temperature measured by measuring unit 9. Control unit 10 controls the air volume of each of fans 14 and 15 based on the temperature measured by measuring unit 9 or the current flowing through coil 1. Furthermore, control unit 10 controls the raising and lowering operation of lifting and lowering unit 4. Control unit 10 includes, for example, a CPU

(Central Processing Unit), a ROM (Read Only Memory), and a RAM (Random Access Memory). Control unit 10 includes operation unit 101 and display unit 102. Operation unit 101 accepts various operations such as setting the firing temperature and the firing time. Display unit 102 displays various information.

Upper heat insulating body 11 is provided above flow path member 8. Upper heat insulating body 11 has a substantially square shape when viewed from above. Upper heat insulating body 11 includes bottom surface 111, inner circumferential surface 112, outer surface 113, and top surface 114. Bottom surface 111 of upper heat insulating body 11 is in contact with upper end surface 84 of flow path member 8. Flow path member 8 extends downward from bottom surface 111 of upper heat insulating body 11. Inner circumferential surface 83 of flow path member 8 and inner circumferential surface 112 of upper heat insulating body 11 constitute a continuous curved surface.

Housing 12 contains coil 1, induction heating element 2, lower heat insulating body 3, lifting and lowering unit 4, ceiling part 6, flow path members 7 and 8, measuring unit 9, and upper heat insulating body 11 inside. Housing 12 has a substantially rectangular parallelepiped shape. Housing 12 is made of a material such as aluminum which has good heat dissipation properties and generates little heat due to dielectricity. Housing 12 includes bottom surface 121, inner circumferential surface 122, ceiling surface 123, multiple through holes 124 to 127, top surface 128, and outer surface 129.

Bottom surface 121 of housing 12 is in contact with bottom surface 324 of flange part 32. Through hole 124 for accepting lifting and lowering unit 4 is formed at bottom surface 121 of housing 12

Inner circumferential surface 122 of housing 12 is in contact with each of outer surface 325 of flange part 32 and outer surface 113 of upper heat insulating body 11. Inner circumferential surface 122 of housing 12 faces coil 1 and outer surface 82 of flow path member 8 with space SP3 in between. A plurality of through holes 125 are each formed at a position facing coil 1 at inner circumferential surface 122 of housing 12. A plurality of through holes 126 are each formed at a position corresponding to the outer peripheral side end of straight groove 323 at inner circumferential surface 122 of housing 12.

Ceiling surface 123 of housing 12 is in contact with top surface 114 of upper heat insulating body 11. Ceiling surface 123 of housing 12 faces top surface 63 of ceiling part 6 across space SP4. A part of measuring unit 9 is provided in space SP4. A plurality of through holes 127 are each formed above flow path SP2 at ceiling surface 123 of housing 12.

Overhanging part 13 is placed above housing 12. Overhanging part 13 and top surface 128 of housing 12 constitute space SP5. Space SP5 exists above space SP4 with housing 12 in between. A part of measuring unit 9 is provided in space SP5. Overhanging part 13 includes top surface 131 and through hole 132. Through hole 132 is formed at the central part of top surface 131.

The fan 14 is fixed to top surface 131 of overhanging part 13 so as to cover through hole 132. The fan 14 promotes gas flow in the flow path SP2. Here, the fan 14 circulates air taken in from outside the housing 12 to the flow path SP2.

Note that the fan 14 may be fixed to the outer surface 129 of the housing 12 so as to cover the through hole 126. Further, the fan 14 may discharge air taken in from the flow path SP2 to the outside of the housing 12.

The fan 15 is fixed to the outer surface 129 of the housing 12 so as to cover one of the plurality of through holes 125. The fan 15 blows air to coil 1. The fan 15 blows gas (here, air taken in from the outside of the housing 12) toward the coil 1 from, for example, the outer diameter direction of the coil 1.

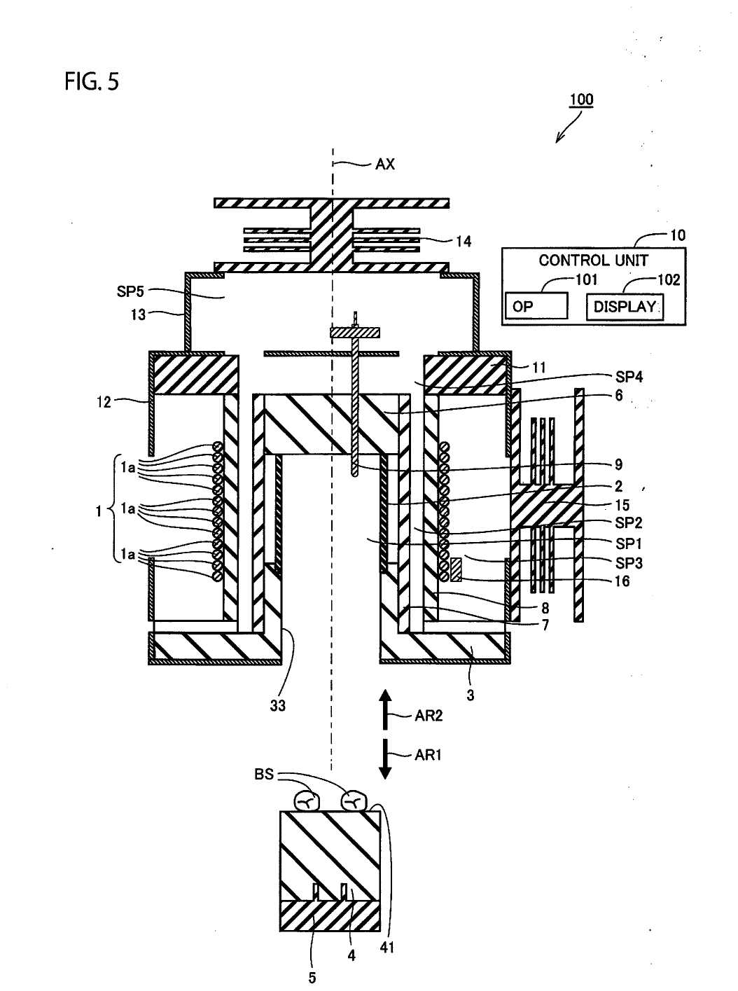

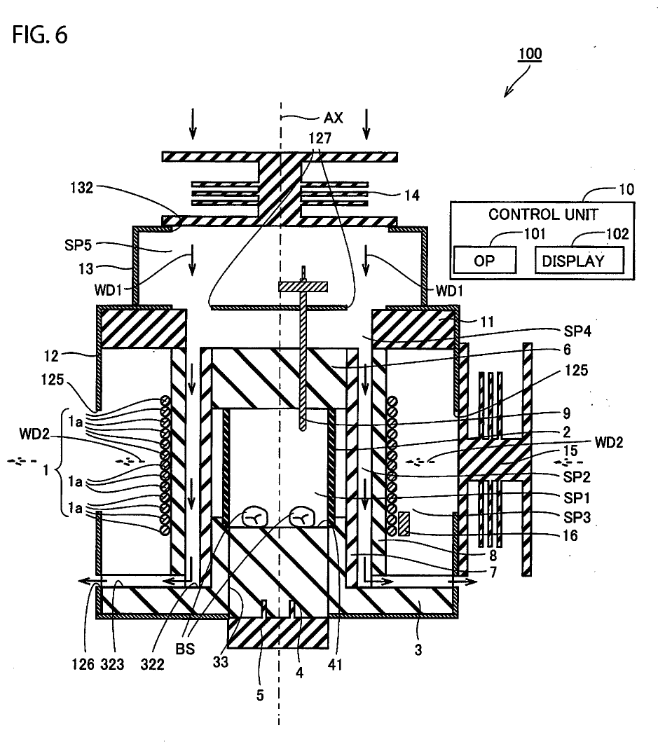

FIGS. 5 and 6 are cross-sectional views explaining the operation of firing furnace 100.

Referring to FIG. 5, when control unit 10 receives a predetermined operation at operation unit 101, it lowers lifting and lowering unit 4 along axis AX, as shown by arrow AR1. Lifting and lowering unit 4 is lowered to the position where lower hole 33 is opened (In other words, the position below lower hole 33). Hence, the stage 41 of lifting and lowering unit 4 is exposed to the outside of housing 12.

Next, the user of firing furnace 100 places objects to be fired BS on the stage 41 of lifting and lowering unit 4. Here, several built-up dental porcelains are shown as the objects to be fired BS. Note that the object to be fired BS may be placed at any position in the hollow portion SP2.

Next, when control unit 10 receives a predetermined operation at operation unit 101, it raises lifting and lowering unit 4 along axis AX, as shown by arrow AR2. Lifting and lowering unit 4 is raised to the position where it blocks lower hole 33 (In other words, the position mated with lower hole 33). Hence, with the objects to be fired BS housed in the hollow portion SP1, the hollow portion SP1 is sealed.

Referring to FIG. 6, when control unit 10 receives a predetermined operation at operation unit 101, it applies an alternating voltage to coil 1 to cause alternating current to flow through coil 1. Due to the fluctuation of the magnetic field generated by coil 1, an induced current flows in induction heating element 2. Induction heating element 2 is heated by this induced current, and the heated induction heating element 2 heats the inside of hollow portion SP1, thereby the objects to be fired BS are heated. Based on the temperature obtained from measuring unit 9, so that the inside of hollow portion SP1 is at a required firing temperature during a required firing time, control unit 10 controls the frequency, voltage, etc. of the AC voltage applied to coil 1.

Coil 1 is cooled by the gas flowing through flow path SP2. Since the gas in flow path SP2 is heated by induction heating element 2, natural convection of gas occurs in flow path SP2. For this reason, fan 14 may be omitted.

The control unit 10 rotates each of the fans 14 and 15 at the necessary timing from the start of firing to the time of cooling after the end of firing. Based on the set firing time, the elapsed time since the start of firing, or the temperature obtained from measuring unit 9, control unit 10 may control the wind force (rotation speed) of each of fans 14 and 15.

As shown by the solid arrow WD1, the fan 14 circulates air taken in from outside the housing 12 to the flow path SP2, and discharges it to the outside of the housing 12. That is, air taken in from the outside of housing 12 passes through the through hole 132, space SP5, through hole 127, and space SP4 in this order, and enters flow path SP2. This air travels downward within flow path SP2 and hits a bottom surface of circular groove 322. Thereafter, the air changes its traveling direction to the horizontal direction, travels inside the straight groove 323, and is discharged to the outside of the housing 12 through the through hole 126. The direction of air blowing by the fan 14 may be opposite to the arrow WD1.

As shown by the dotted arrow WD2, the fan 15 blows the air taken in from the outside of the housing 12 to the coil 1 portion facing the fan 15, and discharges it to the outside of the housing 12. That is, air taken in from the outside of housing 12 passes through the through hole 125 and space SP3 where fan 15 is provided, and hits the coil 1 portion facing fan 15. The air that hits coil 1 travels through space SP3 along the outer surface of coil 1 and passes through the through hole 125, which is different from through hole 125 where fan 15 is installed, to be discharged to the outside of housing 12. The direction of air blowing by the fan 15 may be opposite to the arrow WD2.

The firing furnace 100 may further include a measuring unit 16 (an example of a second measuring unit) that measures the temperature of the coil 1. Further based on the temperature measured by the measuring unit 16, the control unit 10 may control at least one of the current flowing to the coil 1 and the fan for cooling the firing furnace 100. Here, the fan for cooling the firing furnace 100 means at least one of the fans 14 and 15.

When the measured value of measuring unit 16 exceeds a first temperature, control unit 10 may determine an abnormality and perform the forced cooling control. The forced cooling control may include at least one of stopping the current flowing to coil 1 and blowing air to coil 1 (here, blowing air by at least one of fans 14 and 15). When the measured value that exceeds the first temperature subsequently falls below a second temperature (the second temperature is equal to or lower than the first temperature), control unit 10 may stop the forced cooling control, and return to the normal control for firing as described above.

In this way, by measuring the temperature of coil 1 and performing the forced cooling control based on the measured value, it is possible to monitor damage on coil 1 due to overload and maintain an appropriate firing cycle.

The coil 1 itself is heated by the current flowing through the conducting wire that constitutes the coil 1, and is also heated by the conductive heat from the dielectric heating element 2. For this reason, coil 1 is easily damaged by heat. Especially when coil 1 consists of litz wire 1a, coil 1 is easily damaged by heat. According to this embodiment, flow path SP2 is configured by flow path members 7 and 8 placed between coil 1 and induction heating element 2, and coil 1 is cooled by the gas flowing through flow path SP2, so that coil 1 is prevented from overheating. As a result, the amount of current flowing through coil 1 can be increased, and the time required for firing can be shortened. Furthermore, since coil 1 is cooled by gas, the amount of cooling of the coil can be suppressed compared to when the coil is water-cooled. Hence, coil 1 can be heated efficiently and energy can be saved. Further, since a water circulation device for cooling the coil 1 can be omitted, cost savings can be achieved.

After firing, in order to shorten the waiting time to start the next cycle of firing, it is necessary to cool down induction heating element 2 as quickly as possible after firing ends. According to this embodiment, induction heating element 2 can also be cooled as required by the gas flowing through flow path SP2.

In addition, according to this embodiment, by adopting coil 1 made of litz wire 1a, induction heating element 2 can be heated efficiently. Typically, as the frequency increases, the skin effect causes the current to flow only on the surface of the conductor, and the proximity effect causes adjacent electric fields to negatively influence each other's electromagnetic distribution. As a result, the high frequency loss of the conducting wire increases. The litz wire has the effect of reducing the high frequency loss of this conducting wire.

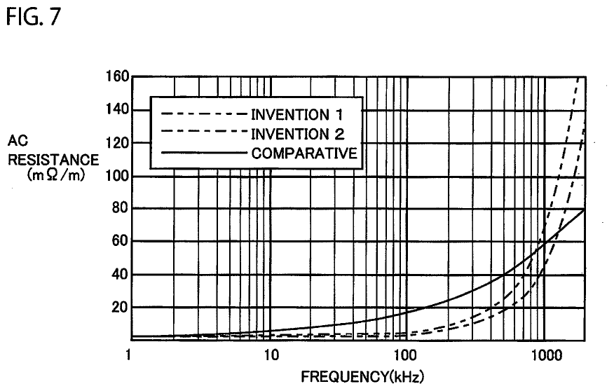

FIG. 7 is a diagram showing frequency characteristics of AC resistances.

Referring to FIG. 7, an example of the present invention 1 is with a litz wire consisting of 510 bare wires each having a diameter of 0.1 millimeter. An example of the present invention 2 is with a litz wire consisting of 1036 bare wires each has a diameter of 0.07 millimeters. The comparative example uses a copper single wire. The equivalent conductor cross-sectional area of each of the example of the present invention 1, the example of the present invention 2, and the comparative example is 4.0 millimeter 2. As is clear from FIG. 7, the AC resistances of each of examples of the present inventions 1 and 2 are smaller than the AC resistance of the comparative example at high frequencies in the range of about 10 KHz to about 1 MHz.

According to this embodiment, by adopting coil 1 consisting of litz wire 1a, it is possible to increase the amount of current of coil 1 and the frequency of the current of coil 1, which efficiently heats induction heating element 2. As a result, the time required for firing can be shortened. As an example, according to this embodiment, hollow portion SP1 can be heated from a room temperature to 1500 degrees Celsius to 1600 degrees Celsius in less than 5 minutes.

By providing the fan 14, it is possible to promote the flow of gas in flow path SP2. Hence, coil 1 can be efficiently cooled.

By providing the straight groove 323 in the flange part 32, the gas that is warmed when flowing through the flow path SP2 can be quickly discharged to the outside of the housing 12.

By providing the fan 15, air can be blown toward coil 1 from the outer diameter direction of coil 1. Hence, coil 1 can be cooled efficiently.

Since the amount of current in a coil is large, if liquid such as water is used to cool the coil, there are concerns that the coil may be short-circuited or the structure may become larger. According to this embodiment, since gas is used to cool coil 1, short-circuiting of coil 1 can be prevented and reliability of the firing furnace can be improved. Further, the configuration can be made smaller.

### [Others]

The embodiments described above should be considered exemplary in all respects and not restrictive. The scope of the present invention is shown not by the above description but by the scope of the claims, and is intended to include meanings equivalent to the scope of the claims and all modifications within the scope.

### EXPLANATION OF SYMBOLS

1 coil (an example of a coil)
1a litz wire of coil (an example of a litz wire)
1b bare wire of litz wire (an example of a bare wire)
1c insulation film of the litz wire
2 induction heating element (an example of an induction heating element)
3 lower heat insulating body (an example of a heat insulating body)
4 lifting and lowering unit (an example of a lifting and lowering unit)
5 drive unit
6 ceiling part (an example of a ceiling part)
7,8 flow path member (an example of an inner diameter side flow path member and an outer diameter side flow path member)
9, 16 measuring unit (an example of a first and a second measuring units)
10 control unit (an example of a first and a second control units)
11 upper heat insulating body
12 housing
13 overhanging part
14, 15 fan (examples of a first and a second fans)
21 lower end face of induction heating element
22 outer surface of induction heating element
23 inner circumferential surface of induction heating element
31 main body unit of lower heat insulating body
32 flange part of lower heat insulating body
33 lower hole (an example of a lower hole) of lower heat insulating body
34 recess of lower heat insulating body
41 stage of lifting and lowering unit (an example of a top surface to place an object to be fired)
61 bottom surface of ceiling part
62 outer surface of ceiling part
63 top surface of ceiling part
71 lower end of flow path member
72, 83 inner circumferential surface of flow path member
73,82 outer surface of flow path member
81 lower end surface of flow path member
84 upper end surface of flow path member
100 firing furnace (an example of a firing furnace)
101 operation unit of control unit
102 display unit of control unit
111 bottom surface of upper heat insulating body
112 inner circumferential surface of upper heat insulating body
113 outer surface of upper heat insulating body
114 top surface of upper heat insulating body
121 bottom surface of housing
122 inner circumferential surface of housing
123 ceiling surface of housing
124, 125, 126, 127 through holes of housing
128 top surface of housing
129 outer surface of housing
131 top surface of overhanging part
132 through bole of overhanging part
311 inner circumferential surface of main body unit
311a portion extending upward from recess
312 outer surface of main body unit
321 top surface of flange part
322 circular groove of flange part
323 straight groove of flange part (an example of a groove)
324 bottom surface of flange part
325 outer surface of flange part
341 top surface of recess

AX axis (an example of an axis)

BS objects to be fired

SP1 hollow portion (an example of a hollow portion)

SP2 flow path

SP3, SP4, SP5 spaces

What is claimed is:

1. A firing furnace for firing an object to be fired comprising:
a coil, and
an induction heating element being placed at an inner diameter side of the coil, in which induced current flows due to magnetic field generated by the coil, and generates heat due to the induced current, wherein
the induction heating element includes a hollow portion for locating the object to be fired, and
the coil is made of a conducting wire wound around an axis as a center, wherein the firing furnace further comprising:
an inner diameter side flow path member and an outer diameter side flow path member placed between the coil and the induction heating element, wherein
the inner diameter side flow path member is arranged at an inner diameter side of the outer diameter side flow path member, and
the inner diameter side flow path member and the outer diameter side flow path member constitute a flow path of gas parallel to the axis.

2. The firing furnace according to claim 1, wherein
the conducting wire consists of a litz wire which includes multiple bare wires which are insulated from each other and twisted together.

3. The firing furnace according to claim 1, further comprising:
a first fan that promotes gas flow in the flow path.

4. The firing furnace according to claim 1, further comprising:
a heat insulating body including a groove extending in an outer diameter direction from the flow path.

5. The firing furnace according to claim 4, wherein
the induction heating element has a cylindrical shape with the axis as a center axis, and the heat insulating body includes a lower hole connected to the hollow portion, wherein the firing furnace further comprising
a lifting and lowering unit moves up and down between a lower position where the lower hole is opened and an upper position where the lower hole is closed, and includes a top surface to place an object to be fired.

6. The firing furnace according to claim 5, further comprising:
a ceiling part covering an opening at a top of the induction heating element,
a first measuring unit that hangs from the ceiling part to the hollow portion and measures a temperature of the hollow portion, and
a first control unit that controls a current flowing through the coil based on the temperature measured by the first measuring unit.

7. The firing furnace according to claim 1, further comprising:
a second measuring unit that measures a temperature of the coil, and
a second control unit that performs forced cooling control when the temperature measured by the second measuring unit exceeds a first temperature, wherein
the forced cooling control includes at least one of stopping a current flowing through the coil and blowing air to the coil.

8. The firing furnace according to claim 1, further comprising:
a second fan that blows air to the coil.

9. The firing furnace according to claim 1, wherein:
the induction heating element includes molybdenum disilicide.
